(19) United States
(12) Patent Application Publication
(10) Pub. No.: US 2025/0355617 A1
(43) Pub. Date: Nov. 20, 2025

(54) Headphone Swap Network Protocol

(71) Applicant: SONOS, INC., Goleta, CA (US)

(72) Inventors: Erik RIEGER, Edgewood, KY (US); Ethan E. BISSETT, Somerville, MA (US)

(21) Appl. No.: 19/210,233

(22) Filed: May 16, 2025

Related U.S. Application Data
(60) Provisional application No. 63/649,261, filed on May 17, 2024.

(51) Int. Cl. G06F 3/16; H04R 1/10

(52) U.S. Cl. CPC G06F 3/165; G06F 3/162; H04R 1/1041; H04R 1/1075; H04R 2420/07; H04R 2430/01

(57) ABSTRACT

A headphone assembly communicates a swap command to a playback device. The playback device is emitting playback audio content within an environment. The headphone assembly receives, from the playback device, an audio packet for the playback audio content, The playback device then stops emitting the playback audio content within the environment. The headphone assembly plays back the playback audio content on one or more transducers integrated into one or more earpieces of the headphone assembly.

### CROSS-REFERENCE TO RELATED APPLICATIONS

This application claims the benefit of and priority to U.S. Provisional Application No. 63/649,261 filed on May 17, 2024, and entitled “Headphone Swap Network Protocol,” the contents of which are incorporated by reference herein in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIG. 2 is an illustration of users with headphone assemblies and out-loud playback devices in accordance with aspects of the disclosed technology.

FIG. 3A illustrates a network flow diagram for initiating an audio swap session in accordance with aspects of the disclosed technology.

FIG. 3B illustrates a network flow diagram for ending an audio swap session in accordance with aspects of the disclosed technology.

FIG. 3C illustrates a network flow diagram for disconnecting an audio swap session in accordance with aspects of the disclosed technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Embodiments described herein relate to a headphone swap network protocol. In particular, embodiments describe a protocol for swapping audio from a playback device to a pair of headphones. For example, a playback device in the form of a sound bar may be playing the audio track from a home theater. Disclosed embodiments allow a user to swap the audio track from the sound bar to one or more pairs of headphones. The disclosed embodiments of the headphone swap network protocol facilitate the secure and smooth transition of the audio between the two different playback devices. Such a system provides additional flexibility to users who may wish to switch from a loud and potentially distracting sound bar to a private pair of headphones.

In some embodiments, for example, a headphone assembly (also referred to herein as “headphones” or a “pair of headphones”) may be configured to communicate a swap command from the headphone assembly to a playback device. The playback device may be emitting playback audio content within an environment. The headphone assembly may receive, from the playback device, an audio packet for the playback audio content. The playback devices may then stop emitting the playback audio content within the environment, and the headphone assembly may begin to playback the playback audio.

In some additional or alternative embodiments, a playback device is configured to receive, from a headphone assembly, a swap command. The playback device may be emitting playback audio content within an environment. The playback device communicates, to the headphone assembly, an audio packet for the playback audio content. The playback device may stop emitting the playback audio content within the environment.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

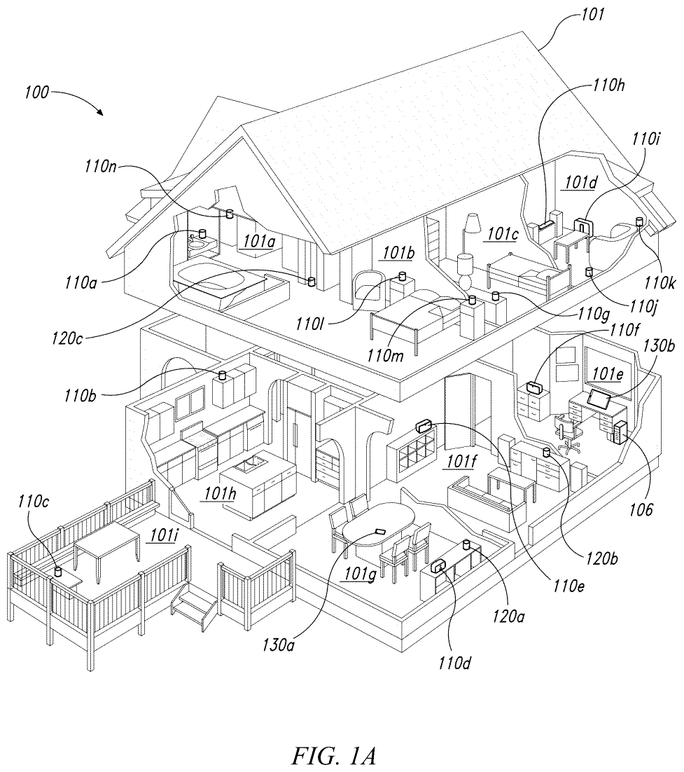

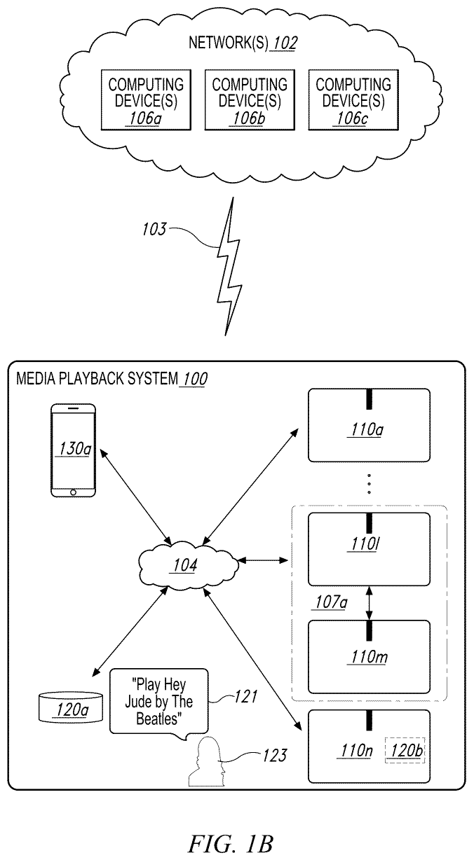

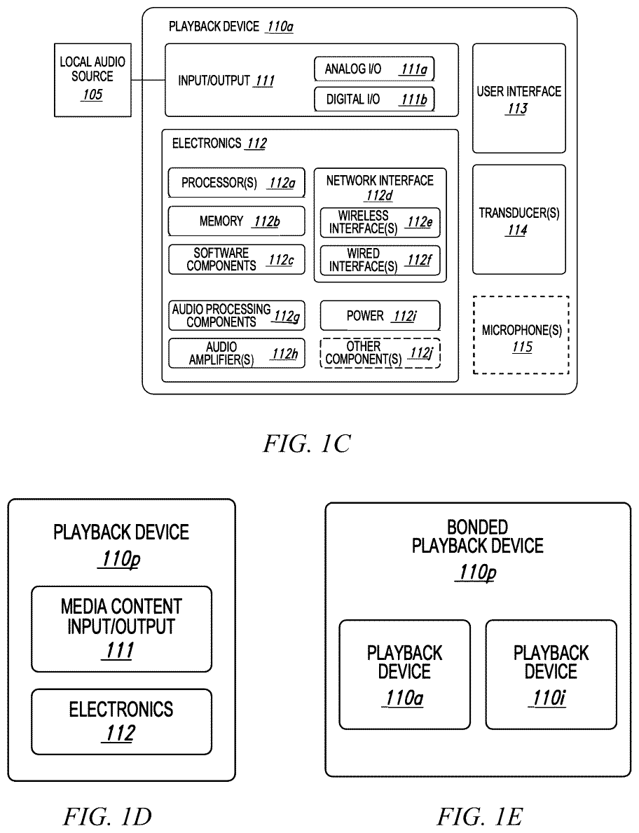

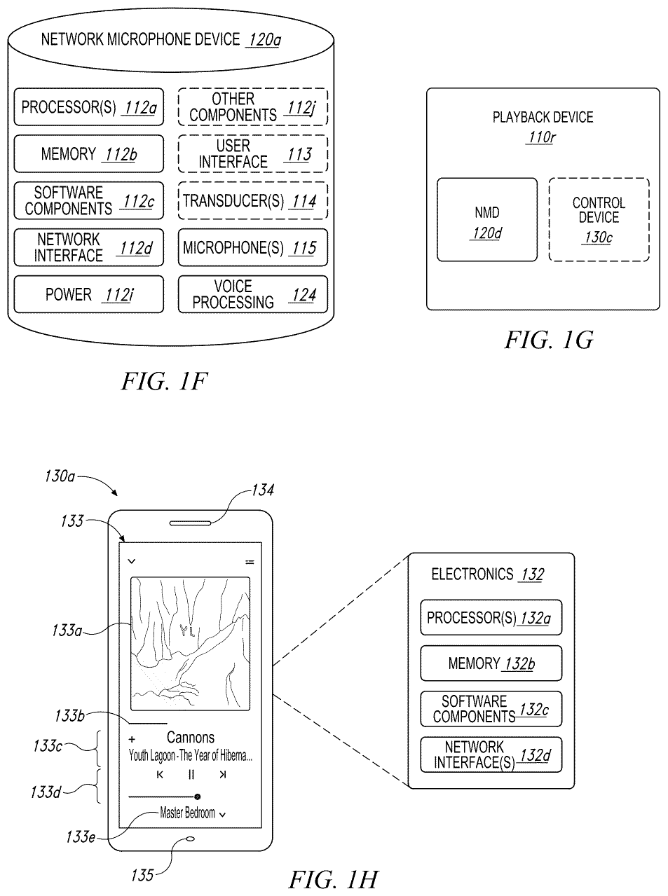

In the Figures, identical reference numbers identify generally similar and/or identical elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a main bathroom 101a, a main bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, main bathroom 101a, main bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the main bathroom 101a, the second bedroom 101c, the office 101e, the living room 101f, the dining room 101g, the kitchen 101h, and the outdoor patio 101i each include one playback device 110, and the main bedroom 101b and the den 101d include a plurality of playback devices 110. In the main bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, 6 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises an High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., Wifi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE @ lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. Example Wireless Audio Swap

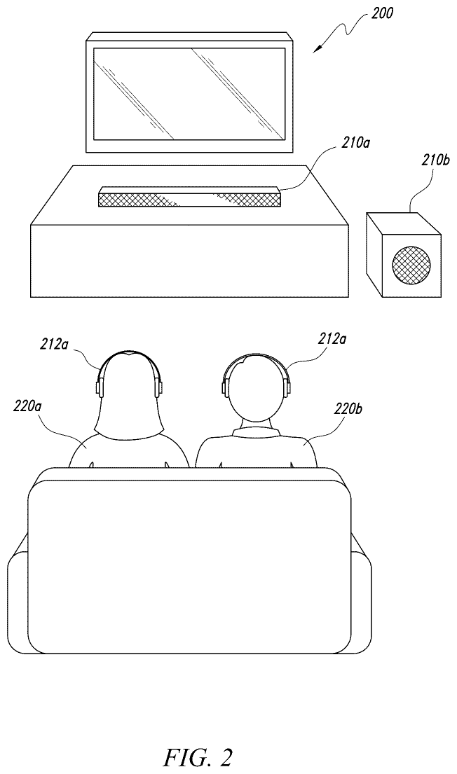

Disclosed embodiments describe systems and methods for allowing a headphone assembly to swap audio with an out-loud playback device. As used herein, an “audio swap” or a “swap” comprises moving the playback of audio content from one or more out-loud playback devices to one or more headphone assemblies. As such, one or more out-loud playback devices would cease emitting the audio content, and instead, one or more headphone assemblies would begin playing the audio content. The transition or handoff from out-loud playback to playback by the headphone assembly is preferably seamless such that the headphone playback continues from where the out-loud playback devices ceased emitting audio content. For example, FIG. 2 depicts an illustration of users with headphone assemblies 212a, 212b and out-loud playback devices 210a, 201b (referred to collectively or singularly as out-loud playback device 210) in accordance with aspects of the disclosed technology. As used herein, an “out-loud playback device” comprises playback devices in the form of speakers. Additionally, as used herein a headphone assembly 212a, 212b (referred to collectively or singularly as headphone assembly 212) includes any over-the-ear, on-the-ear, or in-the-ear playback devices.

In at least one embodiment, a headphone assembly 212 is configured to initiate an audio swap command with an out-loud playback device 210 over a wireless communication protocol such as but not limited to Wifi, Bluetooth, LTE, 5G, Zigbee, Z-Wave, NFC (Near Field Communication), Thread, LoRaWAN, WiMAX, or any other similar protocol. For example, the headphone assembly 212 may connect to an out-loud playback device 210 with a WiFi connection as a station-mode satellite. For example, the headphone assembly 212 may operate similarly to a satellite or surround speaker in a wireless home theater media playback system. In at least one embodiment, a new network protocol may be implemented such that the wireless connection is only between the headphone assembly 212 and the out-loud playback device 210 and does not extend to the upstream LAN. Such a network protocol may provide increased security by effectively segregating communications from the headphone assembly 212 from the rest of the LAN. At least one embodiment of the network protocol does not utilize an IP-based protocol but instead utilizes a different custom protocol for establishing an audio stream from an out-loud playback device 210. For example, a headphone assembly 212 and an out-loud playback device 210 may use raw ethernet packets as the basis for the network protocol. The network protocol by which the headphone assembly 212 and the out-loud playback device 210 communicate over the WiFi channel is adaptable to allow for efficient transmission of audio as well as reliable exchange of commands and responses.

In additional or alternative embodiments, IP-based protocols such as UDP and TCP may be used for audio streaming and control commands. However, allowing a headphone assembly 212 to be IP addressable can raise security concerns, as this could open the headphone assembly 212 to other third-party network traffic and could require more complex packet filtering than would be required for raw ethernet traffic.

Disclosed embodiments may be configured to perform an audio swap from an out-loud playback device 210 to a single headphone assembly 212a or to multiple headphone assemblies 212a, 212b. For example, a first user 220a and a second user 220b may both wear respective headphone assemblies 212a, 212b and both listen to the playback audio content. As will be described further below, each user 220a, 220b may be able to swap audio to or from their respective headphone assembly 212a, 212b independently such that each user 220a, 220b is able to listen to the playback audio content from the out-loud playback device 210 or to another playback audio content source. Additionally, as shown, in at least one embodiment, the out-loud playback device 210 comprises a group 107a or bonded 110p set of out-loud playback devices 210a, 210b. In the depicted example, the out-loud playback devices 210a, 210b comprise bonded playback devices 110p in the form of a soundbar 210a and a subwoofer 210b.

In some embodiments, the headphone assembly 212 and the out-loud playback device 210 can also exchange information outside of the time-sensitive audio packets and head tracking data. For example, the information may include control data such as the current volume, a request to change the volume, temporarily pause streaming to a headphone assembly 212, or informing an out-loud playback device 210 that the audio content is moving from the headphone assembly 212 to the out-loud playback device 210.

To ensure security, disclosed embodiments may use a pre-shared key (PSK) for encryption of WiFi communications. For example, the headphone assembly 212 may use a PSK to authenticate and encrypt with the out-loud playback device 210. This PSK may be securely distributed between a control device 130a, the out-loud playback device 210, and the headphone assembly 212. The control device 130a can have an application-layer encrypted link, on top of a “Just-Works” Bluetooth encrypted link, to the headphone assembly 212. This can be used to securely transfer the PSK and any other corresponding information about the out-loud playback device 210 that the headphone assembly 212 should trust. Concurrently, the control device 130a communicates, through a network layer API, a command to the out-loud playback device 210 about the new headphone assembly 212 and the PSK it will use.

In at least one embodiment, the headphone assembly 212 is the initiating device in the audio playback content transition interaction and operates as a WiFi station-mode device. Additionally or alternatively, another device, such as a control device 130 or an out-loud playback device 210 may be the initiating device. Accordingly, the headphone assembly 212 initiates the association to the access point of the out-loud playback device 210 it chooses. The headphone assembly 212 can choose an out-loud playback device 210 based on BLE advertisements, which may also include WiFi channel information of the out-loud playback device 210. The BLE advertisements can then be used by the headphone assembly 212 to reduce the time it takes to associate to the out-loud playback device 210 by removing the need to scan for the out-loud playback device 210 access point (AP) channels. In some instances, a predetermined order of out-loud playback devices may be stored in the control device 130a.

In at least one embodiment, the network protocol does not include an application-layer data acknowledgment. A conventional application-layer data acknowledgment can require complex buffering on both the out-loud playback device 210 as the audio source and on the headphone assembly 212 as the audio sink. This would likely require a longer presentation delay to allow time for retransmissions, which would also use more power from the additional headphone assembly 212 transmissions.

Following the association of headphone assembly 212 to the out-loud playback device 210, the out-loud playback device 210 attempts to establish authentication and encryption with the headphone assembly 212 using 802.1X and the PSK distributed between the out-loud playback device 210 and headphone assembly 212 during setup through the control device 130a. If headphone assembly 212 successfully authenticates, the out-loud playback device 210 can more securely assume that this is an authentic headphone assembly 212.

In at least one embodiment, the headphone assembly 212 and the out-loud playback device 210 may prefer to communicate through a 5 GHz channel. If the out-loud playback device 210 is in an idle state and the 5 GHZ AP is down, the headphone assembly 212 may first connect to the 2.4 GHz AP. Once successful authentication is established between the out-loud playback device 210 and the headphone assembly 212, the 5 GHZ AP can be brought up and the headphone assembly 212 can then connect to the 5 GHz AP.

a. Command Packet Structure

In order to handle the audio swap features disclosed herein, a structured network protocol and associated commands are needed. To enable a higher level of reliability between headphone assembly 212 and out-loud playback device 210 WiFi communications, a command-response protocol may stipulate that every command packet must have a response packet, which provides an assurance to the commanding device that the packet is received and acknowledged. If a command packet is not responded to within a certain period of time, the commanding device may assume that the command packet was not received. The certain period of time may comprise a threshold time period, such as 30 ms, or may comprise an interval time period, such as three audio packet intervals. In at least one embodiment, there shall only be one outstanding command packet at any time. A command packet is considered no longer outstanding if a response packet is received or a certain period of time is reached. After a timeout, the commanding device can resend a lost command packet, but it is not required to. Additionally, in at least one embodiment, simultaneous commands from each device can also be sent with respective response commands being sent as well. In at least one embodiment, one or more commands may require additional time by the responding side before it can supply requested data in response to the command. In this scenario, an initial response can be given to acknowledge the reception of the command, followed by a later command (from the initial responding device) when the data is ready.

To differentiate the various types of packets that will be sent over WiFi between the out-loud playback device 210 and headphone assembly 212, each packet may have a header with various predetermined fields. Examples of these fields are described in greater detail below.

In at least one embodiment, the network protocol includes packet-length information. For example, each packet may comprise two octets to describe the packet length. In at least one embodiment, the packet length may exclude the octets from both the length field itself and the packet type field. Additionally, the network protocol may include packet-type information. For example, each packet may comprise one octet to describe the packet-type information. The packet-type information. Example values and meanings comprise 0x01=Audio packet, 0x02=IMU (inertial measurement unit) packet, 0x03=control packet, or 0x04=ping packet. In at least one embodiment, all multi-byte fields shall be in network order when transmitting data over a network.

In at least one embodiment, the format of audio data is consistent and known by the headphone assembly 212 before the out-loud playback device 210 streaming session is started. For example, this may include the format of the audio data being LC3, SBC, MP3, AAC, aptX, LDAC, FLAC, ALAC, WAV, WMA, Ogg Vorbis, Opus, or any other conventional encoding. The headphone assembly 212 may also be aware of the configuration parameters used for the audio encoding and the number of frames in each packet (e.g., there may be two frames in each WiFi packet for stereo data).

The data packet may also include a sequence number that allows the headphone assembly 212 to recognize when a packet has been received out of order or not received at all. If the particular embodiment of the network protocol does not provide application layer retransmissions, the headphone assembly 212 can identify from the sequence numbers when packet loss concealment procedures should be initiated locally on the headphone assembly 212. In at least one embodiment, two octets are used for a sequence number field. Additionally, when there are two or more headphone assemblies 212a, 212b communicating with the same out-loud playback device 210, the same sequence number is used for a given audio packet that is sent to both headphone assemblies 212a, 212b. For example, headphone assembly 212a will receive its own audio packets from the out-loud playback device 210 and headphone assembly 212b will also receive its own audio packets from the out-loud playback device 210, but both the respective packets will comprise the same sequence number.

The content of control frames can be varied and potentially expanded for additional embodiments. An adaptable subheader can allow for future additions. An example control packet subheader may comprise one octet for a packet type information. The packet-type information may include the two most significant bits and may include one or more of the values and meanings. Example subheaders include 0b00=command, 0b01=response complete/success, 0b10=response pending, or 0b11=response rejected. The packet type information may further include the six least significant bits for a subpacket ID.

Additionally, a control packet subheader may comprise one octet for packet index information. This index should be incremented each time a new data packet is sent. This prevents retransmitted packets from being processed multiple times by a receiving device. This index may be unique to each MAC address.

Disclosed embodiments may include various control packet types in order to initiate actions within the system. Different commands may be initiated by the out-loud playback device 210 or by the headphone assembly 212. In some cases, the control type determines which of the out-loud playback device 210 or the headphone assembly 212 is the commander and which is the receiver of the command. For example, a command value of 0x00 may correspond to a command for “version request.” The commander, in this case, may comprise an out-loud playback device 210. The data sent with and in response to the version request may comprise one octet for a major version field, one octet for a minor version field, and/or one octet for a patch version field. The version request command may be sent at the beginning of a session to ascertain the compatibility of the two devices. Both the request and the response may include the version fields so that the headphone assembly 212 and the out-loud playback device 210 are mutually aware of each other's versions.

A command value of 0x01 may correspond to a command for “Mute/Unmute streaming.” The commander, in this case, may comprise either the out-loud playback device 210 or the headphone assembly 212. The data sent with the command may comprise one octet with example commands including 0x01 for “enabled” and 0x00 for “disabled.” Additionally, a command value of 0x02 may correspond to a command for “end stream session.” The commander, in this case, may comprise the headphone assembly 212. The data sent with the command may comprise one octet that includes a current in-ear volume setting and/or out-loud volume setting, corresponding to the volume variable used in headphone assembly 212 and/or out-loud playback device 210 communications. Interpretation of this value can be consistent across out-loud playback devices 210a, 210b.

Exchanging this value allows the out-loud playback device 210 to reinitiate playback of the audio playback content at a volume level that corresponds with the volume at which the headphone assembly 212 was playing the audio playback content. For example, a second swap command may be received that causes the audio playback from move from the headphone assembly 212 back to the out-loud playback device 210. Similarly, exchanging this value allows the headphone assembly to reinitiate playback of the audio playback content at a volume level that corresponds with the volume at which the 212 out-loud playback device 210 was playing the audio playback content. As such, users are provided with a unique, immersive experience while performing the audio swap. A user is given the impression that both the out-loud playback device 210 and the headphone assembly 212 are part of a unified audio experience because the volume of the audio emitting from the headphone assembly 212 will substantially match the volume of the audio from the out-loud playback device 210 when audio swaps occur.

Command values may also include a value of 0x03 for beginning a multi-user streaming session. In this case, the commander may comprise the out-loud playback device 210. In contrast, a command value may include a value of 0x04 for ending a multi-user streaming session. Again, the commander may comprise the out-loud playback device 210.

Additionally, a command value may include a value of 0x05 for setting an initial volume. In this case, the commander may again be the out-loud playback device 210. The data included in this command may comprise one octet describing a current out-loud volume setting, corresponding to the volume variable used in headphone assembly 212 and out-loud playback device 210 communications. Exchanging this value allows the headphone assembly 212 to initiate playback of the audio playback content at a volume level that corresponds with the volume at which the out-loud playback device 210 was playing the audio playback content.

Further, a command value may include a value of 0x06 for a relative-volume up change and another command value may include a value of 0x07 for a relative-volume down change. The commander for both commands may comprise the out-loud playback device 210. The data may include one octet describing a current headphone assembly 212 volume setting, corresponding to the volume variable used in headphone assembly 212 and out-loud playback device 210 communications.

During audio swap streaming, volume control may be locally controlled on each headphone assembly 212. Users 220a, 220b can change their local volume via a user interface on the headphone assembly 212 or through the control device 130. Additionally, if the audio swap streaming session is receiving audio playback content from a show on a TV, the volume on all headphone assemblies 212a, 212b in the audio swap streaming session can be changed through the TV's remote. In this situation, the out-loud playback device 210 can convey the change in volume to each headphone assembly 212 respectively with a relative-volume-up change command. It can do this without knowing the absolute volume on each headphone assembly 212.

A command value may also include a ping frame. The content of ping frames may include a command/response most significant bit in the form of 0b0=command and 0b1=response. The ping identification may comprise the remaining seven least significant bits. The ping identification sent in a ping response may be the same identification that was used in the ping command.

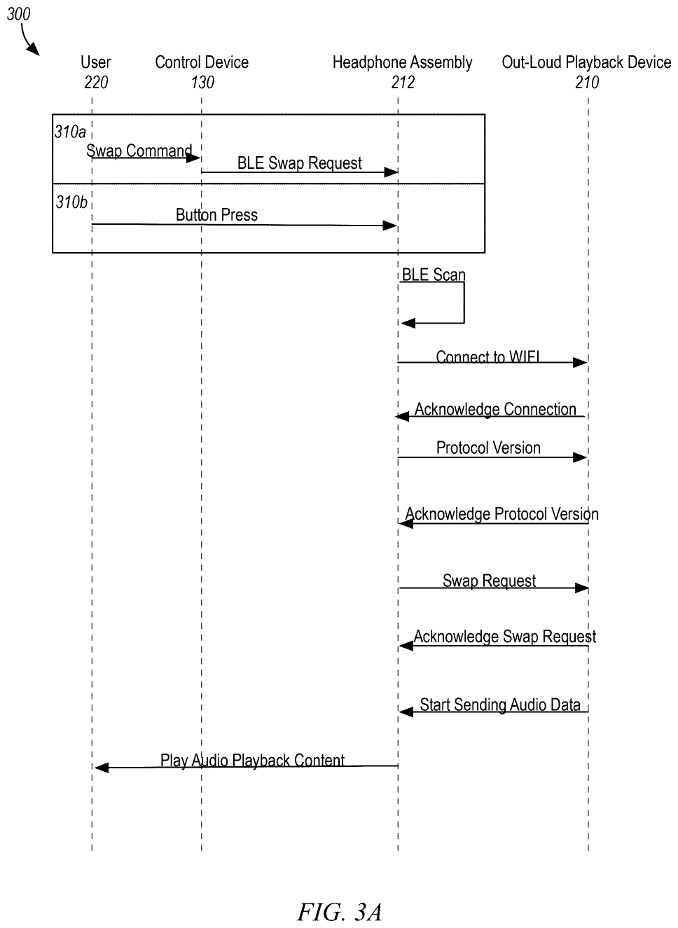

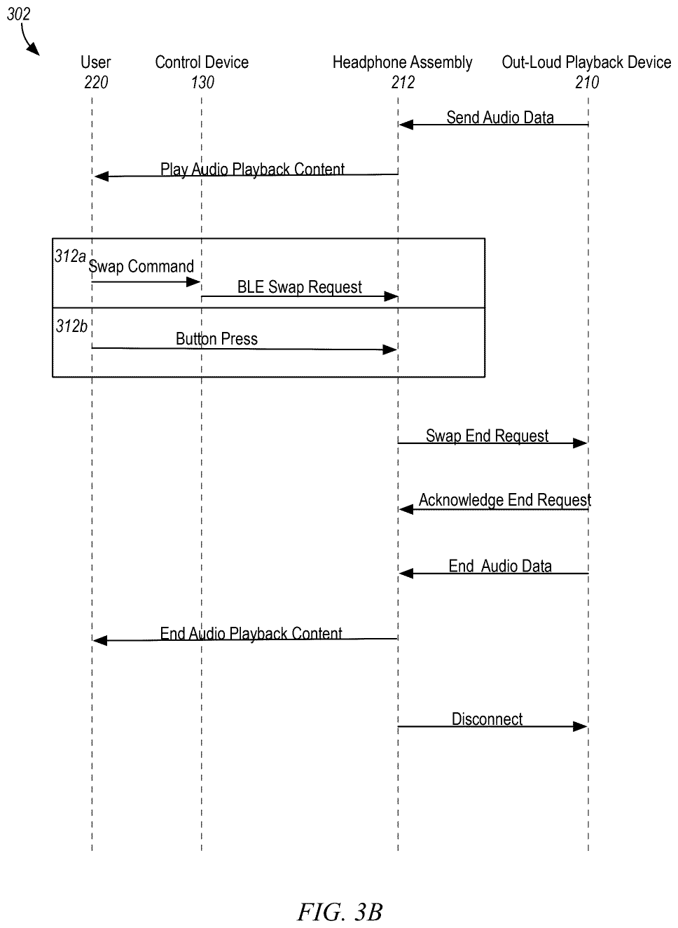

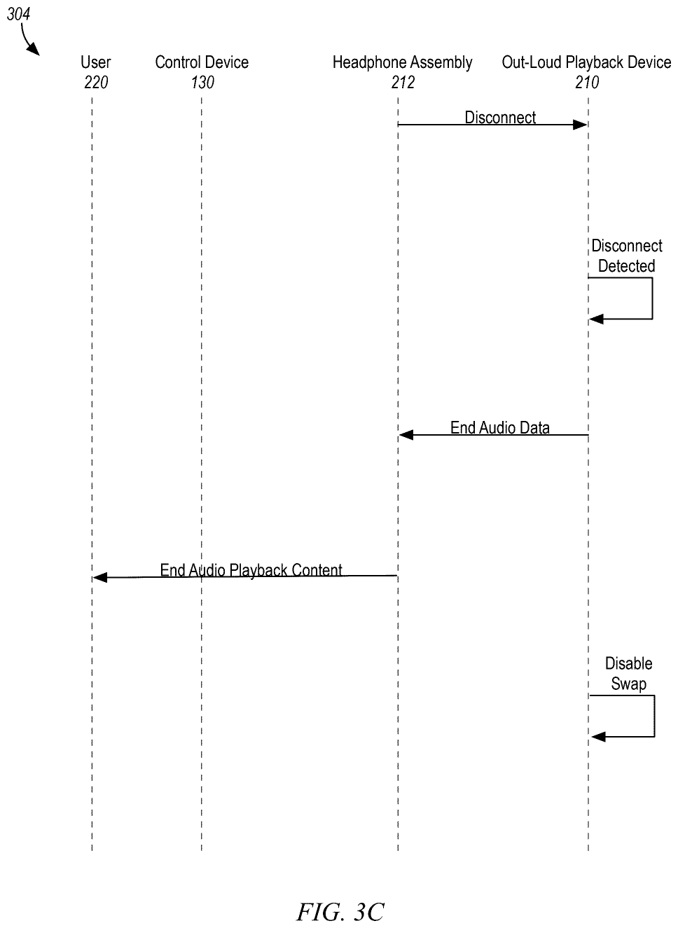

In at least one embodiment, a user 220a may initiate an audio swap from an out-loud playback device 210 to headphone assembly 212 using a hardware interface on the headphone assembly 212. For example, FIG. 3A illustrates a network flow diagram 300a for initiating an audio swap session in accordance with aspects of the disclosed technology. Box 310a depicts a scenario where a user 220a sends an audio swap command through a control device 130, which in turn communicates the audio swap command to the headphone assembly 212. Additionally or alternatively, in box 310b, the user 220a may press and hold a button, slide a switch, or perform some other action on the headphone assembly 212 that initiates the audio swap.

As explained above, the headphone assembly 212 can choose an out-loud playback device 210 based on BLE advertisements, which may also include WiFi channel information of the out-loud playback device 210. The BLE advertisements can then be used by the headphone assembly 212 to reduce the time it takes to associate with the out-loud playback device 210 by removing the need to scan for the out-loud playback device 210 access point (AP) channels. The headphone assembly 212 connects to the out-loud playback device 210 and completes authentication and establishes encryption for the WiFi transport. Additionally, as explained above, the headphone assembly 212 and the out-loud playback device 210 can exchange version information. When the headphone assembly 212 successfully authenticates and encrypts, the out-loud playback device 210 shall then assume that the headphone assembly 212 wants to initiate an audio swap and begin procedures for streaming to the headphone assembly 212.

After the audio swap command is recognized by the out-loud playback device 210, it may send a set-initial-volume command to the new headphone assembly 212. If this is the first headphone assembly 212, the volume value should be indicative of the out-loud volume. If this is the second headphone assembly 212, the initial volume value can be the default value as determined by the user interface. Additionally or alternatively, if this is the second headphone assembly 212, the initial volume value may be set to the current volume of the first headphone assembly 212.

FIG. 3B illustrates a network flow diagram 302 for ending an audio swap session in accordance with aspects of the disclosed technology. For example, the out-loud playback device 210 may be sending audio data to the headphone assembly 212, which in turn plays the audio playback content for the user 220a. The user 220a can request an audio swap back to the out-loud playback device 210 via software on a control device, as shown in box 312a, or via a hardware interface on the headphone assembly 212, as shown in box 312a. The headphone assembly 212 may communicate the swap end request to the out-loud playback device 210, which can acknowledge the request and end the stream of audio data. The headphone assembly 212 will then end the playback of audio playback content to the user and disconnect from the out-loud playback device 210.

From an application level, there may be no differentiation between how a headphone assembly 212 is no longer associated with the out-loud playback device 210, just that it is no longer associated. In at least one embodiment, headphone assembly 212 sends an end-streaming-session command to the out-loud playback device 210. When this command has been responded to by the out-loud playback device 210, the headphone assembly 212 then dissociates from the out-loud playback device 210. If this is the last headphone assembly 212 to leave the out-loud playback device 210 streaming session, the out-loud playback device 210 can then use the last volume setting value to set the out-loud volume. The headphone assembly 212 may attempt to send the command a finite number of times so that other interactions are not delayed, or an audio tone can be played to indicate the failure of the attempted interaction.

In at least one embodiment, the headphone assembly 212 may implicitly send an audio swap command. FIG. 3C illustrates a network flow diagram for disconnecting an audio swap session in accordance with aspects of the disclosed technology. For example, other actions that may be considered to be implicit requests for an audio swap (either to or from the headphone assembly 212) are when a user 220a powers off a headphone assembly 212 or when a headphone assembly 212 loses power or goes out-of-range. If a headphone assembly 212 is able to send a dissociation to the out-loud playback device 210 before powering off, the out-loud playback device 210 can understand the headphone assembly 212 is leaving like the explicit case. But if the headphone assembly 212 is unable to do this and instead disconnects from the out-loud playback device 210, the out-loud playback device 210 cannot know if the headphone assembly 212 is temporarily out of range or powered off semi-permanently.

Once the out-loud playback device 210 detects the disconnect, the out-loud playback device 210 may wait for a certain amount of time before ending the audio data and transitioning back to a muted out-loud streaming state. Either before this time or at this time, the headphone assembly 212 will stop playing the audio playback content to the user 220. The out-loud playback device 210 can limit the number of physical layer retransmissions used for each packet to each headphone assembly 212. This prevents the experience of one headphone assembly 212a deteriorating due to another headphone assembly 212b that moves out of range from the out-loud playback device 210. Similarly, if a headphone assembly 212 is consistently not receiving packets from the out-loud playback device 210, it should be considered lost and disassociated from the out-loud playback device 210.

b. Head Tracking

In at least one embodiment, the headphone assembly 212 can provide head-tracking audio rendering. Audio head tracking technology allows a user to experience the impression that sound is originating from a specific direction as the user moves their head. This is achieved by the headphone assembly 212 using sensors to track the movement of the user's head and adjusting the audio output accordingly. For example, if a user is watching a TV show using headphones, the headphones can use head tracking technology to give the user the impression that the sound is originating from the direction of the TV, even as the user moves their head. The process for tracking movement of the user's head includes maintaining a determination of the orientation of a headphone assembly (and the user's head) is relative to the out-loud playback device 210. Additional details regarding tracking movement of a user's head can be found, for example, in U.S. application Ser. No. 18/411,975, filed on Jan. 12, 2024, and entitled “Spatial Audio Head Tracker,” which is incorporated herein by reference in its entirety.

The network protocol described herein may comprise an IMU data packet. The format of IMU data may be consistent and known by out-loud playback device 210 before the out-loud playback device 210 streaming session is started. For example, the length of the IMU packet can be known by the out-loud playback device 210. A sequence number field can be present in the subheader to allow the out-loud playback device 210 to recognize when a packet may be no longer relevant, for instance, if it has been received out of order. In this embodiment, two octets may be used for the sequence number field.

In at least one embodiment, when only a single headphone assembly 212a is participating in the audio swap stream, the rendering of the head-tracking audio is handled by the out-loud playback device 210. In some embodiments when a second headphone assembly 212b joins the audio swap stream, the head-tracking audio stops due to the processing load required to generate separate audio streams for each headphone assembly 212. In contrast, in at least one embodiment, when a second headphone assembly 212b joins the audio swap stream, the rendering of the head-tracking audio is shifted from the out-loud playback device 210 to being locally computed on each headphone assembly 212. Allowing the out-loud playback device 210 to render the head-tracking audio for a single headphone assembly 212a allows for an efficient use of power and computation abilities.

Typically, a headphone assembly 212a is operated on battery power and may have limited processing capabilities. As such, the out-loud playback device 210, which is often powered by an outlet and may have greater processing abilities, can render the head-tracking audio without depleting the batteries of the headphone assembly 212a. Nevertheless, at some point the computational load for even the out-loud playback device 210 may be too great if it is asked to render multiple separate head-tracking audio streams. As such, after a threshold number of headphone assemblies 212a, 212b join the audio swap steam, the out-loud playback device 210 may pass the rendering of the head-tracking audio stream to each headphone assembly 212a, 212b for local rendering. In the above example, the out-loud playback device 210 is portrayed as only being able to render head-tracking audio for a single headphone assembly but one of skill in the art will appreciate that this limitation is device dependent and some out-loud playback devices 210 may be able to render multiple head-tracking audio streams.

In at least one embodiment, the first headphone assembly 212a may not be aware that the second headphone assembly 212b has joined, so the out-loud playback device 210 can issue a command for beginning a multi-user streaming session. This command can inform the first headphone assembly 212a to begin initiating procedures to transition the head tracking rendering to itself and cease sending IMU data to the out-loud playback device 210.

Additional details regarding detecting other playback devices can be found, for example, in U.S. Pat. No. 11,188,294, which is incorporated herein by reference in its entirety. Additionally, details regarding audio swap network protocols can be found, for example, in U.S. application Ser. No. 19/200,330 filed on May 6, 2025, and entitled “Sound Swapping of Wearable Playback Devices and A Playback Zone,” which is incorporated herein by reference in its entirety.

As further explanation, FIG. 3A provides an example flow between a headphone assembly 212 and an out-loud playback device 210 (e.g., a soundbar) via BLE and Wi-Fi for initiating a swap session, as generally described in U.S. application Ser. No. 19/200,330, and more specifically described with respect to FIG. 10E of U.S. application Ser. No. 19/200,330. FIG. 3B of the present application starting with 312a details the message exchange that occurs to end the swap sessions described in U.S. application Ser. No. 19/200,330.

Accordingly, various network protocols and functions are provided for swapping audio between out-loud playback devices 210 and to headphone assemblies 212. These protocols provide for head tracking functionality and the ability to match volume levels to the various devices to the volumes that were previously being played. Additionally, these protocols provide for the consistent handling of the audio swaps between devices, including between out-loud playback devices 210 and multiple headphone assemblies 212.

### IV. CONCLUSION

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for the implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A headphone assembly comprising:
one or more earpieces;
one or more transducers integrated into the one or more earpieces;
a communication interface;
at least one processor; and
at least one non-transitory computer-readable medium comprising program instructions that are executable by the at least one processor such that the headphone assembly is configured to:
communicate, from the headphone assembly to a playback device, a swap command, wherein the playback device is emitting playback audio content within an environment;
receive, from the playback device, an audio packet for the playback audio content, wherein the playback device stops emitting the playback audio content within the environment; and
play back the playback audio content on the one or more transducers integrated into the one or more earpieces.

2. The headphone assembly as recited in claim 1, wherein the playback device comprises an out-loud playback device.

3. The headphone assembly as recited in claim 1, wherein the swap command is communicated to the playback device without utilizing an IP-based protocol.

4. The headphone assembly as recited in claim 1, wherein the swap command is communicated over a network protocol that does not include an application-layer data acknowledgement.

5. The headphone assembly as recited in claim 1, wherein the program instructions comprise further instructions that are executable by the at least one processor such that the headphone assembly is configured to:
receive, from the playback device, a current out-loud volume setting.

6. The headphone assembly as recited in claim 5, wherein the program instructions comprise further instructions that are executable by the at least one processor such that the headphone assembly is configured to cause the headphone assembly to play back the playback audio content at a particular volume determined based upon the current out-loud volume setting.

7. A method for swapping playback from a playback device to a headphone assembly, the method comprising:
communicating, to the playback device, a swap command, wherein the playback device is emitting playback audio content within an environment;
receiving, from the playback device at the headphone assembly, an audio packet for the playback audio content, wherein the playback device stops emitting the playback audio content within the environment; and
playing back the playback audio content at the headphone assembly.

8. The method as recited in claim 7, further comprising:
receiving, from the playback device, the audio packet for the playback audio content at a second headphone assembly; and
playing back the playback audio content at the second headphone assembly.

9. The method as recited in claim 7, wherein the playback device comprises a group or bonded set of out-loud playback devices.

10. The method as recited in claim 7, further comprising:
communicating the swap command from a control device.

11. The method as recited in claim 7, further comprising:
sending, to the playback device, a current in-ear volume setting.

12. The method as recited in claim 11, further comprising:
communicating, from the headphone assembly to the playback device, a second swap command, wherein the headphone assembly is playing back playback audio content; and
playing back the playback audio content at the playback device at a particular volume determined based upon the current in-ear volume setting.

13. The method as recited in claim 7, further comprising:
sending, to the headphone assembly from the playback device, a current out-loud volume setting.

14. The method as recited in claim 13, further comprising:
playing back the playback audio content at the headphone assembly at a particular volume determined based upon the current out-loud volume setting.

15. A playback device comprising:
a communication interface;
at least one processor; and
at least one non-transitory computer-readable medium comprising program instructions that are executable by the at least one processor such that the playback device is configured to:
receive, from a headphone assembly, a swap command, wherein the playback device is emitting playback audio content within an environment;
communicate, to the headphone assembly, an audio packet for the playback audio content; and
stopping the playback device from emitting the playback audio content within the environment.

16. The playback device as recited in claim 15, wherein the playback device comprises a group or bonded set of out-loud playback devices.

17. The playback device as recited in claim 15, wherein the swap command is received from the headphone assembly without utilizing an IP-based protocol.

18. The playback device as recited in claim 15, wherein the swap command is communicated over a network protocol that does not include an application-layer data acknowledgement.

19. The playback device as recited in claim 15, wherein the program instructions comprise further instructions that are executable by the at least one processor such that the headphone assembly is configured to:
send, to the headphone assembly, a current out-loud volume setting.

20. The playback device as recited in claim 19, wherein the headphone assembly is configured to play back the playback audio content at a particular volume determined based upon the current out-loud volume setting.
